(19) United States
(12) Patent Application Publication
(10) Pub. No.: US 2023/0235227 A1
(43) Pub. Date: Jul. 27, 2023

(54) CALCIUM CARBONATE AGRICULTURAL PRODUCTS AND METHODS OF USING THE SAME

(71) Applicant: Okeanos Group, LLC, Miami Beach, FL (US)

(72) Inventors: Larry Wyman, Miami Beach, FL (US); Russell Petrie, Irvine, CA (US); Florencio Cuetara, Miami Beach, FL (US); Ray Loflin, Cincinnati, OH (US)

(21) Appl. No.: 18/157,711

(22) Filed: Jan. 20, 2023

Related U.S. Application Data
(60) Provisional application No. 63/267,042, filed on Jan. 21, 2022.

(51) Int. Cl. C09K 17/50

(52) U.S. Cl. CPC C09K 17/50; C09K 2101/00

(57) ABSTRACT

A calcium carbonate agricultural product includes calcium carbonate. The calcium carbonate agricultural product may be used to replace any suitable agricultural plastic currently in use. A method of growing plants includes providing a calcium carbonate agricultural product including calcium carbonate to protect the plants. A method for controlling a pH of soil includes: providing a calcium carbonate agricultural product including calcium carbonate to the soil; and releasing the calcium carbonate of the calcium carbonate agricultural product to the soil.

### CROSS-REFERENCE TO RELATED APPLICATION(S)

The present application claims priority to and the benefit of U.S. Provisional Application No. 63/267,042, filed in the United States Patent and Trademark Office on Jan. 21, 2022, the entire content of which is incorporated herein by reference.

### BACKGROUND

The agricultural industry utilizes agricultural plastics for a wide variety of uses and products, including, but not limited to mulching films, pesticide containers, bale films and nets, expanded polystyrene (EPS) boxes, irrigation drip tape, fishing nets and ropes, cages, plastic bags, net floats, fertilizer containers, plant pots, seedling plugs, plastic ties, ropes, twines, bags for feed, bale twine, greenhouse films, tree guards, pond liners, irrigation tubes and drips, ear tags, and crates for harvesting. For example, agricultural coverings may be utilized to protect and/or warm plants and/or animals. For example, an agricultural covering may be placed over the plants and/or animals to form a housing for the plants and/or animals, and/or the plants may protrude through openings in an agricultural covering that contacts soil that the plants are growing in so that the agricultural covering warms the soil and prevents or reduces growth of weeds adjacent to the plants. Agricultural coverings made of polymers (e.g., plastics) that are used for plants become too dirty to be recycled and may be shredded or ground up and embedded in the soil, thereby contributing to plastic (e.g., microplastic) pollution. In some instances, the plastic films are shredded or ground every 40 days, thereby providing a significant source of plastic pollution. Further, any of the above-described agricultural plastics may be left in the soil or open environment, thereby contributing to plastic pollution. Plastic pollution is an increasing global issue, and therefore, it is desirable to find an alternative to the agricultural plastics that are currently used in the agricultural industry.

### SUMMARY

A calcium carbonate agricultural product according to embodiments of the present disclosure includes calcium carbonate. The calcium carbonate agricultural product may be a mulching film, a pesticide container, a bale film, a bale net, an expanded polystyrene box substitute, an irrigation drip tape, a fishing net, a fishing rope, a cage, a plastic bag, a net float, a fertilizer container, a plant pot, a seedling plug, a plastic tie, a rope, twine, a bag for feed, bale twine, a greenhouse film, a tree guard, a pond liner, an irrigation tube, an irrigation drip, an ear tag, or a crate for harvesting. The calcium carbonate may be present in the calcium carbonate agricultural product at an amount of 20 wt % or more based on the total weight of the calcium carbonate agricultural product. The calcium carbonate agricultural product may further include a binder and/or an additive. In some embodiments, the calcium carbonate agricultural product does not include an additive. The calcium carbonate agricultural product may include the additive and the additive may accelerate (e.g., increase) decomposition (e.g., degradation) of the calcium carbonate agricultural product. The calcium carbonate agricultural product may include the binder and the binder may include a polymer, cellulose, and/or protein (e.g., industrial protein). The calcium carbonate agricultural product may include the polymer and the polymer may include ethylene vinyl alcohol (EVOH) and/or polyvinyl alcohol (PVOH). The calcium carbonate agricultural product may be configured to release the calcium carbonate to soil during a set time period. The calcium carbonate agricultural product is configured to control a pH of the soil by releasing the calcium carbonate to the soil. The calcium carbonate agricultural product may be configured to control a pH of soil by being physically mixed with the soil. The calcium carbonate agricultural product may have a plurality of apertures for respective plants to grow through.

According to embodiments of the present disclosure, a method of growing plants includes providing an calcium carbonate agricultural product including calcium carbonate to the plants. The method may further include releasing the calcium carbonate of the calcium carbonate agricultural product to soil during a set time period. The releasing of the calcium carbonate of the calcium carbonate agricultural product to the soil may control a pH of the soil. The method may further include physically mixing the calcium carbonate agricultural product with soil to control a pH of the soil. The providing of the calcium carbonate agricultural product may include placing the calcium carbonate agricultural product on soil so that plants can grow through respective apertures of the calcium carbonate agricultural product. The providing of the calcium carbonate agricultural product may include placing the calcium carbonate agricultural product over plants to form a housing for the plants.

According to embodiments of the present disclosure, a method for controlling pH of soil may include: providing a calcium carbonate agricultural product including calcium carbonate to the soil; and releasing the calcium carbonate of the calcium carbonate agricultural product to the soil. The providing of the calcium carbonate agricultural product to the soil may include placing the calcium carbonate agricultural product on the soil so that plants can grow through respective apertures of the calcium carbonate agricultural product. The providing of the calcium carbonate agricultural product to the soil may include physically mixing the calcium carbonate agricultural product with the soil. The releasing of the calcium carbonate of the calcium carbonate agricultural product to the soil may include decomposing the calcium carbonate agricultural product.

### DETAILED DESCRIPTION

In the following detailed description, only certain embodiments of the subject matter of the present disclosure are described, by way of illustration. As those skilled in the art would recognize, the subject matter of the present disclosure may be embodied in many different forms and should not be construed as being limited to the embodiments set forth herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

A calcium carbonate agricultural product according to embodiments of the present disclosure may be used to form mulching films, pesticide containers, bale films and nets, expanded polystyrene (EPS) boxes, irrigation drip tape, fishing nets and ropes, cages, plastic bags, net floats, fertilizer containers, plant pots, seedling plugs, plastic ties, ropes, twines, bags for feed, bale twine, greenhouse films, tree guards, pond liners, irrigation tubes and drips, ear tags, and crates for harvesting, but the present disclosure is not limited thereto. In some embodiments, the calcium carbonate agricultural product may be used in the agricultural industry as a covering, film, sheet, or layer. The calcium carbonate agricultural product may be used in any suitable manner for plants (e.g., crops, fruits, trees, and the like) and/or any suitable activities associated with the plants, and/or the calcium carbonate agricultural product may be used in any suitable manner for animals (e.g., livestock and the like) and/or any suitable activities associated with the animals. For example, the calcium carbonate agricultural product may be used as an agricultural covering to protect and/or warm plants (e.g., by trapping heat from the sun and/or ambient atmosphere). For example, embodiments of the calcium carbonate agricultural product may be placed over the plants to form a housing for the plants (e.g., a polytunnel, a polyhouse, a hoop house, a hoop green house, a grow tunnel, a high tunnel, or a greenhouse), and/or the respective plants may protrude through apertures (e.g., openings) in a calcium carbonate agricultural product contacting soil that the plants are growing in so that the calcium carbonate agricultural product warms the soil and prevents or reduces growth of weeds adjacent to the plants.

Utilizing embodiments of the calcium carbonate agricultural product including calcium carbonate in the agricultural industry reduces the contribution of the agricultural industry to plastic pollution and may provide additional benefits. For example, because the calcium carbonate agricultural product includes calcium carbonate, the calcium carbonate agricultural product may stabilize or improve the pH of the soil as the calcium carbonate agricultural product decomposes and adds calcium carbonate to the soil. In some embodiments, as the calcium carbonate agricultural product decomposes, calcium carbonate is added to the soil from the calcium carbonate agricultural product, thereby raising the pH of the soil. In 2021, the Food and Agricultural Organization of the United Nations released a report titled “Assessment of agricultural plastics and their sustainability: A call for action,” which highlights the need for plastic alternatives in agriculture but does not mention products including calcium carbonate.

The calcium carbonate agricultural product may include calcium carbonate at an amount of 20 weight percent (wt %) or more based on the total weight of the calcium carbonate agricultural product, but the present disclosure is not limited thereto. For example, the calcium carbonate agricultural product may include calcium carbonate at an amount of 25 wt % or more, 30 wt % or more, 35 wt % or more, 40 wt % or more, 45 wt % or more, 50 wt % or more, 55 wt % or more, 60 wt % or more, 65 wt % or more, 20 wt % to 97 wt %, 25 wt % to 97 wt %, 35 wt % to 97 wt %, 49 wt % to 97 wt %, 35 wt % to 90 wt %, 49 wt % to 90 wt %, 50 wt % to 97 wt %, 50 wt % to 90 wt %, 51 wt % to 97 wt %, 51 wt % to 90 wt %, 54.5 wt % to 97 wt %, 54.5 wt % to 90 wt %, 55 wt % to 97 wt %, 55 wt % to 90 wt %, 60 wt % to 97 wt %, 60 wt % to 90 wt %, 61 wt % to 97 wt %, 61 wt % to 97 wt %, 65 wt % to 97 wt %, 65 wt % to 90 wt %, 70 wt % to 97 wt %, 70 wt % to 90 wt %, 71 wt % to 97 wt %, 71 wt % to 90 wt %, 75 wt % to 97 wt %, 75 wt % to 90 wt %, 80 wt % to 97 wt %, 80 to wt % to 90 wt %, 81 wt % to 97 wt %, 81 wt % to 90 wt %, or any range subsumed therein, based on the total weight of the calcium carbonate agricultural product. By including 20 wt % or more of calcium carbonate, the calcium carbonate agricultural product reduces the amount of polymer used and reduces the carbon (CO₂) footprint of the calcium carbonate agricultural product.

The calcium carbonate agricultural product may be configured to decompose over a set or predetermined time that may coincide with times for pH adjustment of the soil. For example, the decomposition of the calcium carbonate agricultural product and the addition of calcium carbonate to the soil may be configured to correspond with the biological profile of the plants that are being protected and/or warmed by the calcium carbonate agricultural product. In some embodiments, the calcium carbonate agricultural product may be configured to release calcium carbonate into the soil during a set or predetermined time to control the pH of the soil. In some embodiments, the concentration of the calcium carbonate and/or other components of the calcium carbonate agricultural product may be adjusted, and/or an additive may be included in the calcium carbonate agricultural product, so that the calcium carbonate agricultural product releases the calcium carbonate during the set or predetermined time. In some embodiments, the calcium carbonate agricultural product may be physically mixed together with (e.g., plowed into) the soil so that the calcium carbonate agricultural product decomposes and releases calcium carbonate into the soil after having been physically mixed together with the soil. In some embodiments the calcium carbonate agricultural product balances the pH of acidic soils based on a degradation rate of the calcium carbonate agricultural product, thereby harmonizing the pH of the soil with the pH profile or needs of the plants (e.g., crops, fruits, trees, and the like) to maximize or increase agricultural yield and growth performance.

The calcium carbonate agricultural product may be a single layer or a multilayer, and the calcium carbonate agricultural product may have any suitable thickness, shape, and/or design generally used in the art. For example, the thickness of the calcium carbonate agricultural product may be varied when formed as a mulch film so that the mulch film is easily recoverable without (or substantially without) decay.

Embodiments of the calcium carbonate agricultural product may be formed as a mono-material to enhance recyclability and/or reuse, for example, when used as a silage film. In some embodiments, the calcium carbonate agricultural product may include a plurality of layers that are the same as or different from each other. The plurality of layers may have degradation rates that are the same as or different from each other. In some embodiments, one or more of the plurality of layers may include an additive (e.g., a degradant), and/or one or more of the plurality of layers may be free or substantially free of an additive (e.g., a degradant). As used herein, the term “substantially free” means that the cited component is not present, or, if present, is only present as an incidental impurity.

The additive may be any suitable additive generally used in the art that accelerates degradation of a polymer. In some embodiments, the additive may include an oxo-degradable additive (e.g., an oxo-biodegradable additive), but the present disclosure is not limited thereto, and the additive may be include any suitable additive generally used in the art that accelerates degradation of a polymer. For example, the additive may not include, and may be completely free of, oxo-degradable additives and oxo-biodegradable additives. In some embodiments, the calcium carbonate agricultural product is completely free of oxo-degradable additive and oxo-biodegradable additives. The calcium carbonate agricultural product may include that the additive in an amount of 0.01 wt % to 20 wt % (or 0.01 wt % to 10 wt %), based on the total weight of the calcium carbonate agricultural product. The additive (e.g., the oxo-degradable additive) may increase the rate at which the polymer oxo-degrades when exposed to oxygen. For example, the oxo-degradable additive may increase the rate at which the polymer is oxidized. The polymer may breakdown when exposed to oxygen without the need for bacteria microbes to initially break down the polymer. After (or concurrently or simultaneously with) the oxidation of the polymer, organisms (e.g., microbes, bacteria and/or the like) may further degrade the remaining portions of the polymer. This process may be referred to as oxo-biodegradation. Thus, the oxo-degradable additive causes the polymer to oxo-biodegrade.

The additive may include any suitable additive that increases the rate at which the polymer is oxidized or oxo-biodegraded. The additive may include any non-heavy metal additive or salt that complies with European Union Packaging Waste Directive 94/62, Article 11 and similar U.S. laws and/or regulations. In some embodiments, the oxo-degradable additive includes a salt such as, for example, an iron salt, a manganese salt, a cobalt salt, and/or any suitable non-heavy metal salt, but the present disclosure is not limited thereto. As used herein, the term “heavy metal” may refer to those elements that are restricted under European Union Packaging Waste Directive 94/62, Article 11. Non-limiting, non-heavy metal, commercially available examples of the oxo-degradable additive include those available from Willow Ridge Plastics Inc. (Erlanger, Ky.) and/or Bio-Tec Environmental, LLC (Cedar Crest, N. Mex.).

In some embodiments, a concentration of the additive may vary along a concentration gradient from one side to another side of the calcium carbonate agricultural product. For example, one side of the calcium carbonate agricultural product may be exposed to direct ultraviolet (UV) light (e.g., from the sun), which catalyzes breakdown of the calcium carbonate agricultural product resulting in an increased degradation rate relative to a side that is not directly exposed the UV light. Accordingly, in some embodiments, the side that is not directly exposed to the UV light may have a relatively higher concentration of the additive (e.g., the degradant) while the side exposed to the UV light may have a relatively lower concentration of the additive (e.g., the degradant), or may be free or substantially free of the additive to thereby more closely match a degradation rate of the side directly exposed to the UV light with the degradation rate of the side that is not exposed to the UV light. In some embodiments, the concentration of the additive may decrease along a concentration gradient from the side not directly exposed to the UV light to the side directly exposed to the UV light.

The calcium carbonate agricultural product may be prepared according to any suitable method, including, but not limited to, extrusion, thermoforming, and/or molding together with density reduction. For example, the calcium carbonate agricultural product may be molded, for example, to form pesticide bottles, irrigation tubes, and/or the like, or the calcium carbonate agricultural product may be thermoformed, for example, to form seedling trays, nursery pot trays, and/or the like. The calcium carbonate agricultural product may further include a binder and/or an additive. The additive may be any suitable additive generally used in the art. The additive and the additive may accelerate (e.g., increase) decomposition (e.g., degradation) of the calcium carbonate agricultural product. The binder may be any suitable binder generally used in the art. In some embodiments, the binder may include any suitable polymer, cellulose, and/or protein (e.g., industrial protein) generally used in the art. The polymer may include, for example, ethylene vinyl alcohol (EVOH) and/or polyvinyl alcohol (PVOH).

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

Spatially relative terms, such as “beneath,” “below,” “lower,” “under,” “above,” “upper,” and the like, may be used herein for ease of explanation to describe one element or feature's relationship to another element(s) or feature(s). It will be understood that the spatially relative terms are intended to encompass different orientations of the device in use or in operation, in addition to the orientation described. For example, if the device is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, acts, operations, elements, and/or components, but do not preclude the presence or addition of one or more other features, integers, acts, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the terms “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein. For example, as used herein, the terms “covering,” “film,” “sheet,” and “layer” may be used interchangeably.

While the subject matter of the present disclosure has been described in connection with certain embodiments, it is to be understood that the subject matter of the present disclosure is not limited to the disclosed embodiments, but, on the contrary, the present disclosure is intended to cover various modifications and equivalent arrangements included within the spirit and scope of the appended claims, and equivalents thereof.

What is claimed is:

1. A calcium carbonate agricultural product, the calcium carbonate agricultural product comprising:
calcium carbonate.

2. The calcium carbonate agricultural product of claim 1, further comprising a binder and/or an additive.

3. The calcium carbonate agricultural product of claim 2, wherein the calcium carbonate agricultural product comprises the additive and the additive accelerates decomposition of the calcium carbonate agricultural product.

4. The calcium carbonate agricultural product of claim 2, wherein the calcium carbonate agricultural product comprises the binder and the binder comprises a polymer, cellulose, and/or protein.

5. The calcium carbonate agricultural product of claim 4, wherein the calcium carbonate agricultural product comprises the polymer and the polymer comprises ethylene vinyl alcohol (EVOH) and/or polyvinyl alcohol (PVOH).

6. The calcium carbonate agricultural product of claim 1, wherein the calcium carbonate agricultural product is configured to release the calcium carbonate to soil during a set time period.

7. The calcium carbonate agricultural product of claim 6, wherein the calcium carbonate agricultural product is configured to control a pH of the soil by releasing the calcium carbonate to the soil.

8. The calcium carbonate agricultural product of claim 1, wherein the calcium carbonate agricultural product is configured to control a pH of soil by being physically mixed with the soil.

9. The calcium carbonate agricultural product of claim 1, wherein the calcium carbonate agricultural product has a plurality of apertures for respective plants to grow through.

10. A method of growing plants, the method comprising:
providing a calcium carbonate agricultural product comprising calcium carbonate to protect the plants.

11. The method of claim 10, wherein the calcium carbonate agricultural product further comprises a binder and/or an additive.

12. The method of claim 11, wherein the calcium carbonate agricultural product comprises the additive and the additive accelerates decomposition of the calcium carbonate agricultural product.

13. The method of claim 11, wherein the calcium carbonate agricultural product comprises the binder and the binder comprises a polymer, cellulose, and/or protein.

14. The method of claim 13, wherein the calcium carbonate agricultural product comprises the polymer and the polymer comprises ethylene vinyl alcohol (EVOH) and/or polyvinyl alcohol (PVOH).

15. The method of claim 8, further comprising releasing the calcium carbonate of the calcium carbonate agricultural product to soil during a set time period.

16. The method of claim 15, wherein the releasing of the calcium carbonate of the calcium carbonate agricultural product to the soil controls a pH of the soil.

17. The method of claim 10, further comprising physically mixing the calcium carbonate agricultural product with soil to control a pH of the soil.

18. The method of claim 10, wherein the providing of the calcium carbonate agricultural product comprises placing the calcium carbonate agricultural product on soil so that plants can grow through respective apertures of the calcium carbonate agricultural product.

19. The method of claim 10, wherein the providing of the calcium carbonate agricultural product comprises placing the calcium carbonate agricultural product over plants to form a housing for the plants.

20. A method for controlling a pH of soil, the method comprising:
providing a calcium carbonate agricultural product comprising calcium carbonate to the soil; and
releasing the calcium carbonate of the calcium carbonate agricultural product to the soil.

21. The method of claim 20, wherein the providing of the calcium carbonate agricultural product to the soil comprises placing the calcium carbonate agricultural product on the soil so that plants can grow through respective apertures of the calcium carbonate agricultural product.

22. The method of claim 20, wherein the providing of the calcium carbonate agricultural product to the soil comprises physically mixing the calcium carbonate agricultural product with the soil.

23. The method of claim 20, wherein the releasing of the calcium carbonate of the calcium carbonate agricultural product to the soil comprises decomposing the calcium carbonate agricultural product.

24. The method of claim 20, wherein the calcium carbonate agricultural product further comprises a binder and/or an additive.

25. The method of claim 24, wherein the calcium carbonate agricultural product comprises the additive and the additive accelerates decomposition of the calcium carbonate agricultural product.

26. The method of claim 24, wherein the calcium carbonate agricultural product comprises the binder and the binder comprises a polymer, cellulose, and/or protein.

27. The method of claim 26, wherein the calcium carbonate agricultural product comprises the polymer and the polymer comprises ethylene vinyl alcohol (EVOH) and/or polyvinyl alcohol (PVOH).

28. The method of claim 20, wherein the providing of the calcium carbonate agricultural product to the soil comprises placing the calcium carbonate agricultural product over plants to form a housing for the plants.

29. A calcium carbonate agricultural product, the calcium carbonate agricultural product comprising:
calcium carbonate,
wherein the calcium carbonate agricultural product is a mulching film, a pesticide container, a bale film, a bale net, an expanded polystyrene box substitute, an irrigation drip tape, a fishing net, a fishing rope, a cage, a plastic bag, a net float, a fertilizer container, a plant pot, a seedling plug, a plastic tie, a rope, twine, a bag for feed, bale twine, a greenhouse film, a tree guard, a pond liner, an irrigation tube, an irrigation drip, an ear tag, or a crate for harvesting.
